(19) United States
(12) Patent Application Publication
(10) Pub. No.: US 2016/0253120 A1
(43) Pub. Date: Sep. 1, 2016

(54) MULTICORE PROGRAMMING APPARATUS AND METHOD

(71) Applicant: ELECTRONICS AND TELECOMMUNICATIONS RESEARCH INSTITUTE, Daejeon (KR)

(72) Inventors: Duk-Kyun WOO, Daejeon (KR); Sang-Cheol KIM, Daejeon (KR); Jun-Keun SONG, Daejeon (KR)

(21) Appl. No.: 14/813,608

(22) Filed: Jul. 30, 2015

(30) Foreign Application Priority Data
Feb. 27, 2015 (KR) 10-2015-0028595

(51) Int. Cl. G06F 3/06

(52) U.S. Cl. CPC G06F 3/0631; G06F 3/0604; G06F 3/0644; G06F 3/065; G06F 3/0673

(57) ABSTRACT

The present invention relates to an apparatus and a method for performing a multicore program in a cross development environment having a multicore target board.

A multicore programming apparatus according to the present invention to which a target board on which a memory and a multicore are mounted is connected, comprises: a link script generator configured to generate a link script based on memory map specification; and a cross compiler configured to compile a multicore program to generate a binary code corresponding to the program, wherein the cross compiler generates a shared section or a nonshared section to store shared or nonshared variables in the binary code by using the link script information.

### CROSS REFERENCE TO RELATED APPLICATION

This application claims the benefit of Korean Patent Application No. 10-2015-0028595, filed on Feb. 27, 2015, entitled “Multicore Programming Apparatus and Method”, which is hereby incorporated by reference in its entirety into this application.

### BACKGROUND OF THE INVENTION

1. Technical Field

Exemplary embodiments of the present invention relate to multicore programming and more particularly, to an apparatus and a method for performing a multicore program in a cross development environment having a multicore target board.

2. Description of the Related Art

Use of multicores in embedded systems is on the rise with the popularization of multicore hardware from multicores which have been used in conventional PC environments. However, it is a burden of developing methods for merging programs which are used in conventional single core environments to those in multicore environments or developing new codes in multicore environments to developers who are familiar to single core environments.

Particularly, it is difficult for developers to write or change a source code by determining whether a variable be shared between cores in the multicore environment.

### SUMMARY OF THE INVENTION

Accordingly, exemplary embodiments of the present invention provide a multicore programming apparatus and method which is able to support programming similar to that used in the conventional single core environment in developing source codes in the multicore environment.

According to an aspect of the present invention, there is provided a multicore programming apparatus. The apparatus, to which a target board on which a memory and a multicore are mounted is connected, may comprise: a link script generator configured to generate a link script based on memory map specification; and a cross compiler configured to compile a multicore program to generate a binary code corresponding to the program, wherein the cross compiler generates a shared section or a nonshared section to store shared or nonshared variables in the binary code by using the link script information.

In an embodiment, the memory map specification may comprise at least one of shared or nonshared area allocation availability of a variable of which shareable attribute is not explicitly declared, the number of cores, a physical memory size, and size information of the allocated shared or nonshared area.

When it is set for the variable of which a shareable attribute is not explicitly declared in the memory map specification to be allocated in the nonshared area of the memory, the link script generator may generate the link script in order for the cross compiler to generate a shared section, in which the variable of which the shareable attribute is explicitly declared as ‘shared’ are to be stored, in the binary code.

On the other hand, when it is set for the variable of which a shareable attribute is not explicitly declared in the memory map specification to be allocated in the shared area of the memory, the link script generator may generate the link script in order for the cross compiler to generate a nonshared section, in which the variable of which the shareable attribute is explicitly declared as ‘nonshared’ are to be stored, in the binary code.

In an embodiment, the apparatus may further comprise a loader agent configured to transmit at least one of the memory map specification and the binary code to the target board.

In an embodiment, the target board may further comprise a multicore program loader configured to partition the memory into a shared area and a nonshared area based on the memory map.

The multicore program loader may execute the binary code by copying a shared section of the binary code in the shared area and copying a nonshared section in the nonshared area.

According to another aspect of the present invention, there is provided a multicore programming method, which is to develop a multicore program to be executed in a target board on which a memory and a multicore are mounted. The method may comprise: partitioning the memory into a shared area and a nonshared area based on memory map specification; and generating a binary code corresponding to a multicore by compiling the program, wherein the binary code is generated to store the variable in the shared or the nonshared area of the memory according to shareable attributes of a variable which is explicitly declared in the program.

According to exemplary embodiments of the present invention, when source codes of a single core environment are merged to those of a multicore environment or when new source codes of a multicore environment are developed, it allows to reduce time and cost for merging to/developing multicore programs by being programmed similar to those in the single core environment.

It further allows to shorten time and cost for developing multicore programs in the multicore environment by being programmed similar to those in the single core environment.

It still further allows to provide a multicore program performing environment with high reliability since global variables which are allocated in a nonshared memory area are memory-protected from other cores.

### BRIEF DESCRIPTION OF DRAWINGS

FIG. 1 illustrates an embodiment of merging a program (source code) written in a single core environment to that in a multicore environment.

FIG. 2 illustrates an embodiment of allocation of global variables based on a shared/nonshared memory allocation method according to the present invention.

FIG. 3 is a block view illustrating configuration of a multicore programming apparatus according to an embodiment of the present invention.

FIG. 4 illustrates a memory map specification.

FIG. 5A illustrates a physical memory layout which is partitioned into a shared area and nonshared areas according to the present invention and FIG. 5B illustrates a virtual memory layout which is partitioned into a shared area and a nonshared area.

FIGS. 6A and 6B are examples of declaration of shareable attributes to allocate global variables of a source code in a shared area and a nonshared area.

FIGS. 7A and 7B illustrate structures of binary code sections generated by compiling the source code in FIGS. 6A and 6B.

FIG. 8 is a flowchart illustrating a multicore programming method according to an embodiment of the present invention.

FIG. 9 is a flowchart illustrating the multicore programming method in FIG. 8 in more detail.

### DESCRIPTION OF THE EXEMPLARY EMBODIMENTS

While the present invention has been described with reference to particular embodiments, it is to be appreciated that various changes and modifications may be made by those skilled in the art without departing from the spirit and scope of the present invention, as defined by the appended claims and their equivalents.

Throughout the description of the present invention, when describing a certain technology is determined to evade the point of the present invention, the pertinent detailed description will be omitted.

Unless clearly used otherwise, expressions in the singular number used in the present invention include a plural meaning.

In addition, “module”, “unit”, “interface” and the like among terms used in the present invention generally mean objects relating to a computer such as hardware, software and combinations thereof.

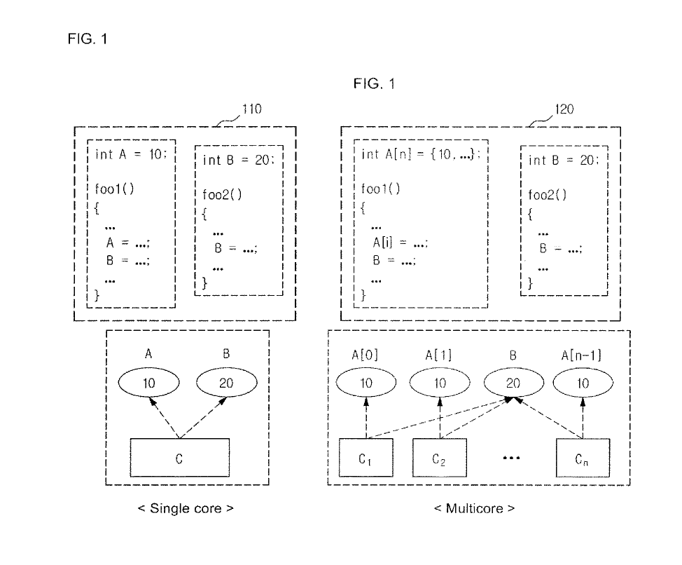

FIG. 1 illustrates an embodiment of merging a program (source code) written in a single core environment to that in a multicore environment. Particularly, a source code 110 is a program of a single core and a source code 120 is a program in a multicore environment merged from the source code 110. It is assumed that a variable A is used only in a foo1( ) function and a variable B is used in the foo1( ) function and a foo2( ) function. Both the variable A and the variable B may be accessed in order by a single core C in the single core environment. However, when this program is merged to the multicore environment composed with a plurality of cores C₁, C₂, . . . Cₙ, each of the foo1( ) function and the foo2( ) function may be run in parallel in a different core. Here, it is assumed that the variable A is accessed independently by each core and the variable B is accessed and shared by each core. A source code may be corrected to use the variable A which is defined and arranged as numerous as the number of each core in order to implement this condition in the multicore environment. When scale of the source code is large, it may cause of increasing development time since each variable should be identified to correct the source code.

A system automatically may allocate global variables in a shared memory or a nonshared memory and a user easily may conduct multicore programming by describing a keyword such as shared or nonshared in global variable declaration in order to resolve such problems.

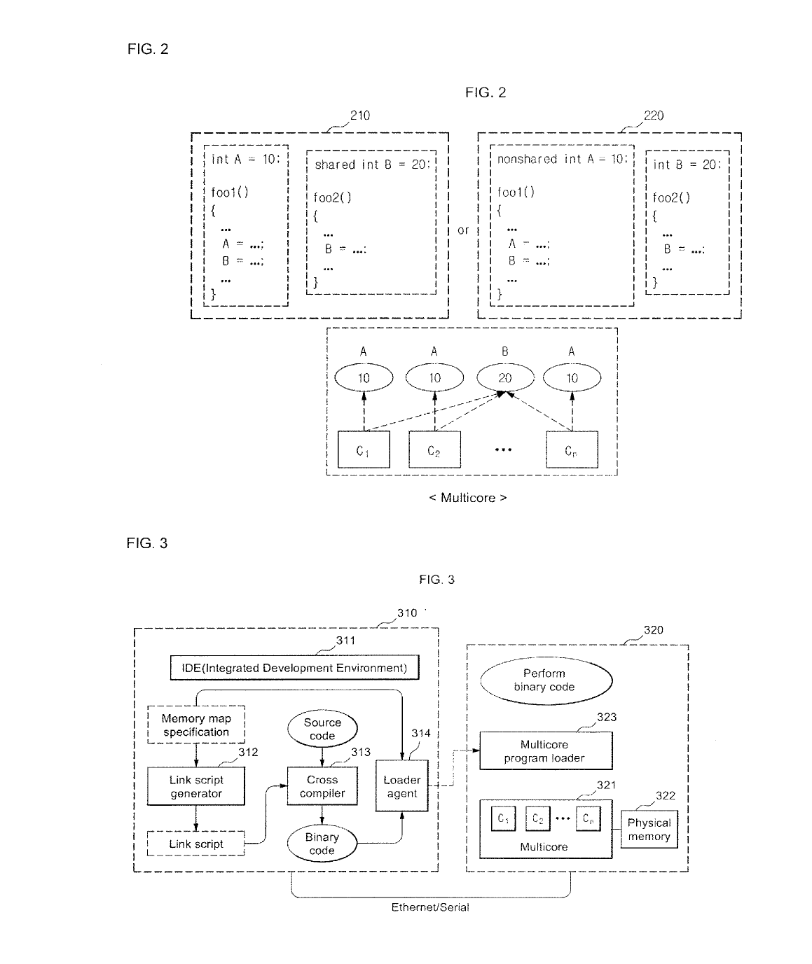

FIG. 2 illustrates an embodiment of allocation of global variables based on a shared/nonshared memory allocation method according to the present invention.

Referring to FIG. 2, a variable A is allocated in a nonshared memory which a core independently manages and a variable B is allocated in a shared memory which each core shares to access.

A left source code 210 is a case in which a global variable B is explicitly declared as ‘shared’. Here, the global variable B may be allocated in the shared memory and the global variable A may be allocated in the nonshared memory.

A right source code 220 is a case in which the global variable A is explicitly declared as ‘nonshared’. Here, the global variable A may be also allocated in the nonshared memory and the global variable B may be allocated in the shared memory. As a result, it is noted that it is allocated in the same way as the source code 210.

FIG. 3 is a block view illustrating configuration of a multicore programming apparatus according to an embodiment of the present invention.

As shown in FIG. 3, a multicore programming apparatus 310 is a computing apparatus (e.g., a desktop, a laptop and the like) that is configured for providing a programming development environment to user and may be connected with a target board 320, on which a physical memory and a multicore are mounted.

The multicore programming apparatus 310 and the target board 320 may be connected through ethernet or serial.

In an embodiment, the multicore programming apparatus 310 may include an IDE (Integrated Development Environment) 311, a link script generator 312, a cross compiler 313 and a loader agent 314.

The IDE 311 is software which provides an environment in which all operations related to program developments of program coding, editing, debugging, compiling and the like are processed in one program. The IDE 311 may provide the environment where such operations can be performed by a user through a conversational interface.

The link script generator 312 may generate a link script based on memory map specification. In an embodiment, the memory map specification may include at least one of shared or nonshared memory allocation availability of global variables of which a shareable attribute (shared/nonshared) is not explicitly declared in the source code, the number of cores, a physical memory size, and shared or nonshared memory size information.

A user may order to generate the link script after the memory map specification is made through the IDE 311. When the command to generate the link script is received from the user, the link script generator 312 may generate the link script.

When a program source code of which a shareable attribute (shared/nonshared) is explicitly declared is compiled, the link script may be transmitted to the cross compiler 313 to be used to generate a shared section or a nonshared section in addition to an original text section, a data section and a bss section in a binary code.

In an embodiment, when it is set for the variable, of which a shareable attribute is not explicitly declared in the memory map specification, to be allocated in the nonshared area of the memory, the link script generator 312 may generate the link script in order for the cross compiler 313 to generate a shared section, in which the variable of which the shareable attribute is explicitly declared as ‘shared’ is to be stored, in the binary code.

On the other hand, when it is set for the variable, of which a shareable attribute is not explicitly declared in the memory map specification, to be allocated in the shared area of the memory, the link script generator 312 may generate the link script in order for the cross compiler 313 to generate a nonshared section, in which the variable of which the shareable attribute is explicitly declared as ‘nonshared’ is to be stored, in the binary code.

The cross compiler 313 may compile the multicore program source code developed/corrected by the user to generate a binary code corresponding to the source code, wherein a shared section or a nonshared section in which a shared or nonshared global variable is to be stored may be generated in the binary code using the link script information.

The loader agent 314 may transmit the memory map specification made by the user and the binary code generated by the cross compiler 313 to the target board 320.

In an embodiment, the target board 320 may include a multicore program loader 323 in addition to the multicore 321 and the physical memory 322. The multicore program loader 323 may partition memory space of the physical memory 322 into a shared area and a nonshared area through MMU (Memory Management Unit) settings based on the memory map specification transmitted from the multicore programming apparatus 310 and manage them. The multicore program loader 323 may copy the shared sections and the nonshared sections of the binary code transmitted from the multicore programming apparatus 310 in the shared area and the nonshared area, respectively to execute the binary code. Here, the nonshared sections may be duplicated as numerous as the number of cores to be copied in the nonshared area of each core.

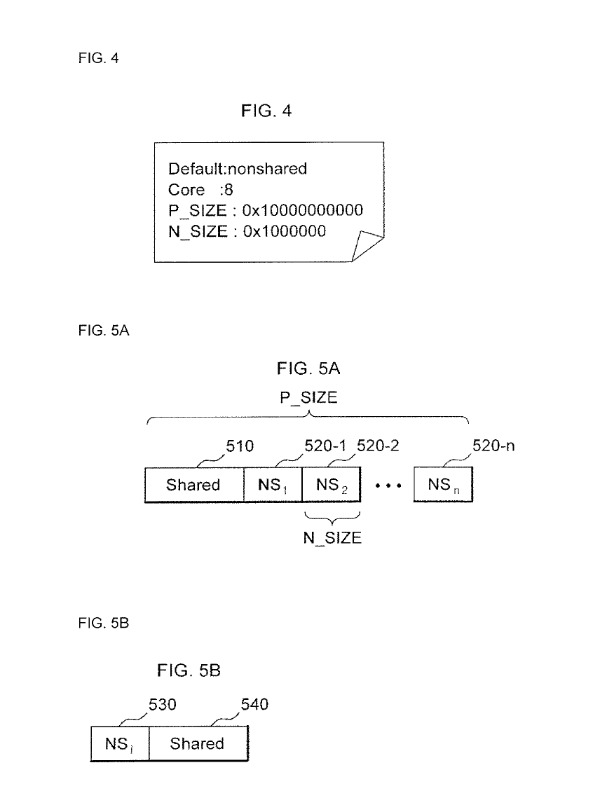

FIG. 4 illustrates a memory map specification.

Referring to FIG. 4, ‘default’ indicates shared/nonshared memory allocation availability of an original global variable of which a shareable attribute (shared/nonshared) is not explicitly declared in the source code. When the user allocates the global variable which is not declared with ‘shared’ or ‘nonshared’ keyword in the shared memory area, ‘default’ may be set as shared, while when the user allocates the global variable which is not declared with ‘shared’ or ‘nonshared’ keyword in the nonshared memory area.

In case that the global variable is “int A=10”, variable A is allocated in the nonshared area because ‘default’ is set as nonshared.

‘Core’ indicates the number of cores, ‘P_SIZE’ indicates size of the physical memory and ‘N_SIZE’ indicates size of the nonshared memory area.

In an embodiment, the number of cores is 8, size of the physical memory area is 4 GB, and size of the nonshared memory area is 64 MB.

FIG. 5A illustrates a physical memory layout which is partitioned into a shared area and nonshared areas according to the present invention and FIG. 5B illustrates a virtual memory layout which is partitioned into a shared area and a nonshared area.

Referring to FIG. 5A, a shared area 510 is a memory space which each core shares and NS, area (520-1 to 520-n) is a nonshared area where the core independently uses. Total size of the physical memory is ‘P_SIZE’ and the nonshared area size of each core is ‘N_SIZE’ of which all are the same.

Referring to FIG. 5B, a virtual memory layout which is accessed by each core may be also partitioned into a nonshared area 530 which each core uses independently and a shared area 540 which each core shares. A virtual memory address may be translated through the memory management unit (MMU), which each core has, into a physical memory address. The virtual memory address is the same between all the cores.

Since nonshared memory access of each core uses the MM provided by hardware, a memory access speed is the same as a conventional shared memory access speed. Each nonshared memory cannot be accessed by other cores so that the memory can be protected.

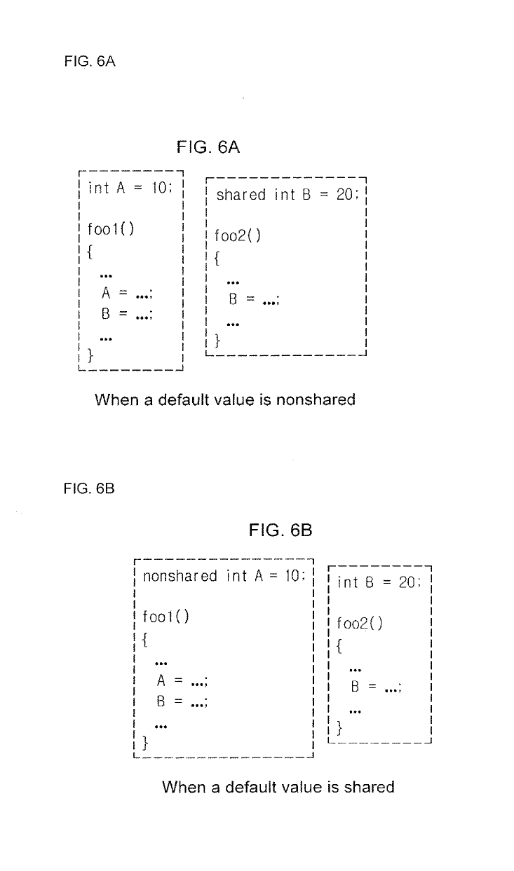

FIGS. 6A and 6B are examples of declaration of shareable attributes to allocate global variables of a source code in a shared area and a nonshared area. When a default value is set for nonshared in the memory map specification as in FIG. 4, any existing variable, which is not declared as shared, may be allocated in the nonshared memory area, while when a default value is set for shared, any existing variable, which is not declared as nonshared, may be allocated in the shared memory area.

FIG. 6A is an example of a source code in which that a variable B is explicitly declared as shared when the default value is set for nonshared. According to the source code, the variable A may be allocated in the nonshared memory with “int A=10” and the variable B may be allocated in the shared memory with “shared int B=20”.

On the other hand, FIG. 6B is an example of a source code in which a variable A is explicitly declared as nonshared when the default value is set for shared. Accordingly, the variable A may be allocated in the nonshared memory with “nonshared int A=10”, while the variable B may be allocated in the shared memory with “int B=20”.

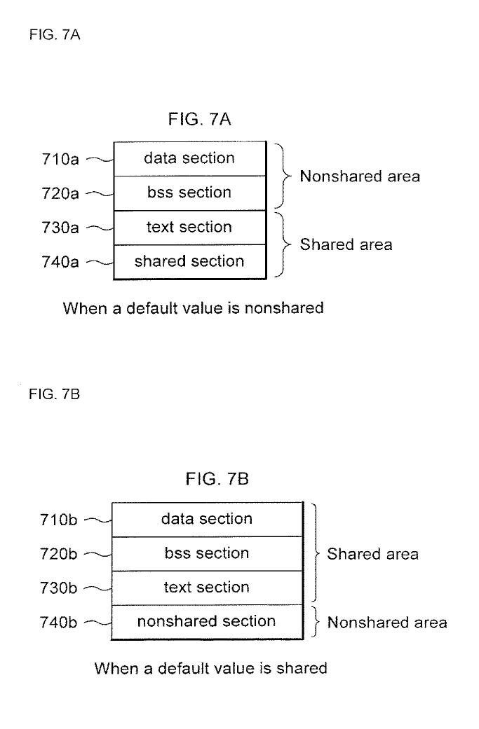

FIGS. 7A and 7B illustrate structures of binary code sections generated by compiling the source code in FIGS. 6A and 6B, respectively. Sections related to program execution may be partitioned into a text section 730a/730b which is a code area, a data section 710a/710b which is data area, and a bss section 720a/720b.

In addition, when the default value in the memory map specification is set for nonshared, the shared section 740a may be added as a new independent section as shown in FIG. 7A and global variables which are declared as shared in the source code may be stored in the shared section 740a. On the other hand, when the default value in the memory map specification is set for shared, the nonshared section 740b may be added as a new independent section as shown in FIG. 7B and global variables which are declared as nonshared in the source code may be stored in the nonshared section 740b.

A shared keyword may be translated to_attribute_((section(“.shared”)) and a nonshared keyword may be translated to_attribute_((section(“.nonshared”)) to be transmitted to the cross compiler 312. The cross compiler 312 may generate automatically shared or nonshared section based on such attribute information. In implementation of the present invention, complier does not need to be modified to process such shared/nonshared keywords.

The text section 730a/730b may be allocated in the shared memory area since it is the area to be shared and referred by each core, while the data section 710a/710b and the bss section 720a/720b may be allocated in the nonshared area or the shared area according to the default value of the memory map specification. FIG. 7A illustrates a case when the default value is set for nonshared. Thus, the data and the bss section 710a, 720a are allocated in the nonshared area and the text and the shared section 730a, 740a are allocated in the shared area. FIG. 7B illustrates a case when the default value is set for shared. Thus, the data section, the bss section, the text section 710b, 720b, 730b are allocated in the shared area and the nonshared section 740b is allocated in the nonshared area.

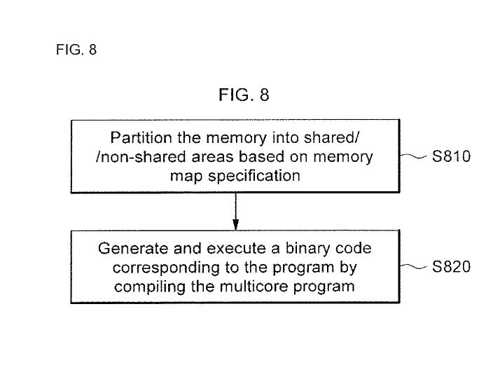

FIG. 8 is a flowchart illustrating a multicore programming method according to an embodiment of the present invention.

A multicore programming process according to an embodiment of the present invention may comprise partitioning a physical memory into shared/nonshared areas in S810 and generating and executing a binary code when a user writes a source code in the memory environment in which the shared/nonshared are partitioned in S820. Here, the binary code may be generated to include shared/nonshared sections to store variables in the shared area or the nonshared area partitioned in the memory based on shareable attributes of the variables which are explicitly declared in the program.

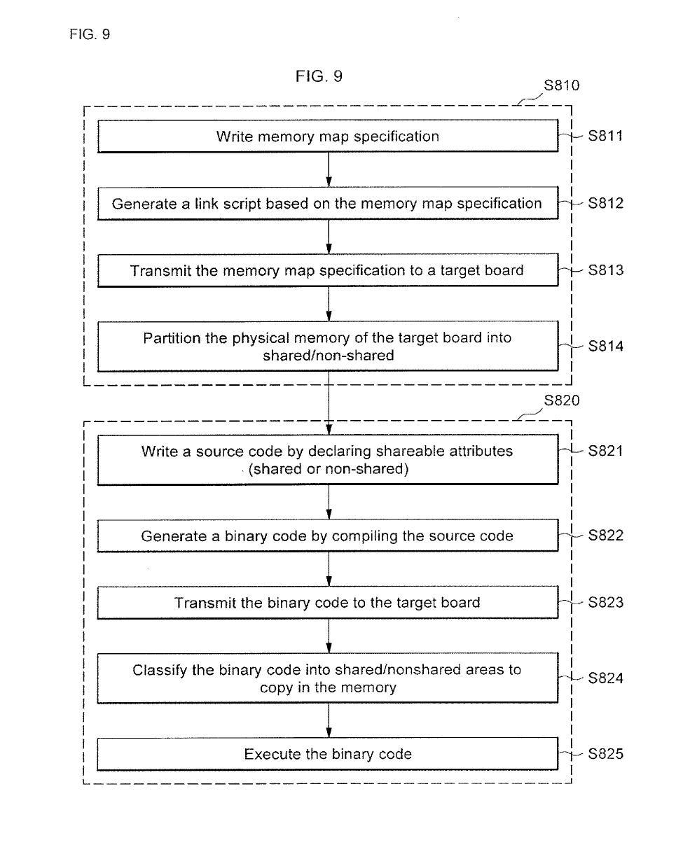

FIG. 9 is a flowchart illustrating the multicore programming method of FIG. 8 in more detail. The process of S810 and S820 described in FIG. 8 will be explained in more detail.

In S811, memory map specification may be made for partitioning a physical memory into shared/nonshared areas in an integrated development environment (IDE). Here, the memory map specification may include at least one of shared or nonshared area allocation availability of a variable of which shareable attribute is not explicitly declared, the number of cores, a physical memory size, and size information of the allocated shared or nonshared area.

In S812, when a command is received to generate a link script through the IDE, the link script may be generated based on the memory map specification. Here, the link script may be used to generate a shared section or a nonshared section, in which the variable of which the shareable attribute is explicitly declared is to be stored, in the binary code during compiling a program.

In an embodiment, when it is set for the variable, of which the shareable attribute is not explicitly declared in the memory map specification, to be allocated in the nonshared area of the memory, the link script may let the shared section, in which the variable of which the shareable attribute is explicitly declared as ‘shared’ is to be stored, be generated in the binary code.

On the other hand, when it is set for the variable of which the shareable attribute is not explicitly declared in the memory map specification to be allocated in the shared area of the memory, the link script may let the nonshared section, in which the variable of which the shareable attribute is explicitly declared as ‘nonshared’ are to be stored, be generated in the binary code.

After the link script is generated, a command for partitioning shared/nonshared areas may be made. The memory map specification may be transmitted to a target board (a multicore program loader in the target board) through ethernet or serial according to the command. The physical memory of the target board may be partitioned into shared/nonshared areas in S814. The multicore program loader in the target board may partition the physical memory into the shared area and the nonshared area through the MMU of each core and mapping between the physical memory and the virtual memory which each core reads according to the memory map specification.

In S821, after memory partitioning through the process from S811 to S814, a source code may be written by declaring shareable attributes (shared or nonshared) of global variables in the IDE.

When the shareable attribute of the memory is set for the global variable, which is not explicitly declared, to be allocated in the nonshared area of the memory, the global variable having a shared attribute may be explicitly declared as ‘shared’. On the other hand, when the shareable attribute of the memory is set for the global variable, which is not explicitly declared, to be allocated in the shared area of the memory, the global variable having a nonshared attribute may be explicitly declared as ‘nonshared’.

In S822, after a compiling is performed in the IDE, the cross compiler may generate a binary code including the shared or nonshared section according to the link script while cross compiling the source code.

When the compile is completed without any fault, a program execution may be performed in the IDE. The compiled binary code may be transmitted to the target board through ethernet or serial in S823.

The target board may analyze the binary code and copy the shared section or the nonshared section in the shared memory area or the nonshared memory area, respectively based on the default value in the memory map specification in S824. The nonshared section stored in the nonshared memory area may be copied according to the number of cores.

In S825, the binary code which is partitioned and stored in the shared/nonshared memory area may be executed.

Exemplary embodiment of the present invention can be implemented by the method which the computer is implemented or in non-volatile computer recording media stored in computer executable instructions. The instructions can perform the method according to at least one embodiment of the present invention when they are executed by a processor. The computer readable medium may include a program instruction, a data file and a data structure or a combination of one or more of these.

The program instruction recorded in the computer readable medium may be specially designed for the present invention or generally known in the art to be available for use. Examples of the computer readable recording medium include a hardware device constructed to store and execute a program instruction, for example, magnetic media such as hard disks, floppy disks, and magnetic tapes, optical media such as CD-ROMs, and DVDs, and magneto-optical media such as floptical disks, read-only memories (ROMs), random access memories (RAMs), and flash memories. In addition, the above described medium may be a transmission medium such as light including a carrier wave transmitting a signal specifying a program instruction and a data structure, a metal line and a wave guide. The program instruction may include a machine code made by a compiler, and a high-level language executable by a computer through an interpreter.

The above described hardware device may be constructed to operate as one or more software modules to perform the operation of the present invention, and vice versa.

While it has been described with reference to particular embodiments, it is to be appreciated that various changes and modifications may be made by those skilled in the art without departing from the spirit and scope of the embodiment herein, as defined by the appended claims and their equivalents. Accordingly, examples described herein are only for explanation and there is no intention to limit the invention. The scope of the present invention should be interpreted by the following claims and it should be interpreted that all spirits equivalent to the following claims fall with the scope of the present invention.

What is claimed is:

1. A multicore programming apparatus to which a target board on which a memory and a multicore are mounted is connected, the apparatus comprising:
a link script generator configured to generate a link script based on memory map specification; and
a cross compiler configured to compile a multicore program to generate a binary code corresponding to the program, wherein the cross compiler generates a shared section or a nonshared section to store shared or nonshared variables in the binary code by using the link script information.

2. The multicore programming apparatus of claim 1, wherein the memory map specification comprises at least one of shared or nonshared area allocation availability of a variable of which shareable attribute is not explicitly declared, the number of cores, a physical memory size, and size information of the allocated shared or nonshared area.

3. The multicore programming apparatus of claim 2, wherein when it is set for the variable of which a shareable attribute is not explicitly declared in the memory map specification to be allocated in the nonshared area of the memory, the link script generator generates the link script in order for the cross compiler to generate a shared section, in which the variable of which the shareable attribute is explicitly declared as ‘shared’ is to be stored, in the binary code.

4. The multicore programming apparatus of claim 2, wherein when it is set for the variable of which a shareable attribute is not explicitly declared in the memory map specification to be allocated in the shared area of the memory, the link script generator generates the link script in order for the cross compiler to generate a nonshared section, in which the variable of which the shareable attribute is explicitly declared as ‘nonshared’ is to be stored, in the binary code.

5. The multicore programming apparatus of claim 1, further comprising a loader agent configured to transmit at least one of the memory map specification and the binary code to the target board.

6. The multicore programming apparatus of claim 1, wherein the target board further comprises a multicore program loader configured to partition the memory into a shared area and a nonshared area based on the memory map.

7. The multicore programming apparatus of claim 6, wherein the multicore program loader executes the binary code by copying a shared section of the binary code in the shared area and copying a nonshared section in the nonshared area.

8. A multicore programming method which is to develop a multicore program to be executed in a target board on which a memory and a multicore are mounted, the method comprising:
partitioning the memory into a shared area and a nonshared area based on memory map specification; and
generating a binary code corresponding to a multicore by compiling the program,
wherein the binary code is generated to store the variable in the shared or the nonshared area of the memory according to shareable attributes of a variable which is explicitly declared in the program.

9. The multicore programming method of claim 8, wherein the memory map specification comprises at least one of shared or nonshared area allocation availability of a variable of which shareable attribute is not explicitly declared, the number of cores, a physical memory size, and size information of the allocated shared or nonshared area.

10. The multicore programming method of claim 9, wherein the memory map specification is made by a user.

11. The multicore programming method of claim 8, further comprising generating a link script based on the memory map specification prior to compiling the multicore program,
wherein the link script is used to generate a shared section or a nonshared section, in which the variable of which the shareable attribute is explicitly declared is to be stored, in the binary code during compiling the program.

12. The multicore programming method of claim 11, wherein when it is set for the variable, of which the shareable attribute is not explicitly declared in the memory map specification, to be allocated in the nonshared area of the memory, the link script lets a shared section, in which the variable of which the shareable attribute is explicitly declared as ‘shared’ is to be stored, be generated in the binary code.

13. The multicore programming method of claim 11, wherein when it is set for the variable of which a shareable attribute is not explicitly declared in the memory map specification to be allocated in the shared area of the memory, the link script lets a nonshared section, in which the variable of which the shareable attribute is explicitly declared as ‘nonshared’ are to be stored, be generated in the binary code.

14. The multicore programming method of claim 8, further comprising executing the binary code on the target board,
wherein the shared section included in the binary code is stored in the shared area and the nonshared section included in the binary code is stored in the nonshared area.
